(19) United States
(12) Patent Application Publication
(10) Pub. No.: US 2021/0369045 A1
(43) Pub. Date: Dec. 2, 2021

(54) HOT BEVERAGE PREPARER WITH A DRAINAGE DEVICE

(71) Applicant: Miele & Cie. KG, Gütersloh (DE)

(72) Inventors: Veronika Kukla, Bielefeld (DE); Timo Falkenreck, Gütersloh (DE); Florian Schobeß, Herford (DE); Dennis Hotzwig, Ahlen (DE)

(21) Appl. No.: 17/303,140

(22) Filed: May 21, 2021

(30) Foreign Application Priority Data
May 27, 2020 (DE) 10 2020 114 157.2
Jul. 24, 2020 (DE) 10 2020 119 558.3

(51) Int. Cl. A47J 31/44; A47J 31/46; A47J 31/52

(52) U.S. Cl. CPC A47J 31/4428; A47J 31/52; A47J 31/468

(57) ABSTRACT

A hot beverage preparer (1) has a flow control system (2) with a water source (14), a brewing unit (40) with a brewing chamber (41) to hold brewing material (51) and an inlet line for supplying water to the brewing chamber (41), a heating device (9) for heating the water supplied to the brewing chamber (41), a pump (8) configured to convey the water from the water source (14) to the brewing chamber (41), a control device (18) to activate and deactivate actuators (8, 9, 72) for preparing a selected beverage, and a drainage device (50) having a collection tray (34) for collecting liquid (AW), with an inlet opening (53) and an outlet opening (52) for draining the collected liquid (AW). The collection tray (34) has a bottom (51) with a slope toward the outlet opening (52) and with at least one trough (56).

### TECHNICAL FIELD

A hot beverage preparer with a flow control system includes a water source; a brewing unit with a brewing chamber for accommodating a substance to be brewed and an inlet line to allow brewing water into the brewing chamber; a heating system for heating the water directed to the brewing chamber; a pump configured to convey the water from the water source to the brewing chamber; a control unit for activating and deactivating the selected actuators for preparation of a chosen beverage; and a drainage device with a collection tray for collecting liquid having an inlet opening and an outlet opening for draining the collected liquid.

### BACKGROUND

A generic hot beverage preparer is known from DE 10 2015 208 212 B3. A filter is disposed immediately above the drainage of the collection tray and is integrated into the collection tray. Thus in this configuration variant, the coffee grounds are collected together with the remaining liquid in the collection tray, wherein the filter ensures that a separation takes place and the waste water is drained away via an outlet present in the collection tray.

### SUMMARY

Thus the invention is based on the objective to present a hot beverage preparer with a simple and improved drainage device.

According to the invention, this objective is met, inter alia, by a hot beverage preparer with a drainage device comprising a collection tray for collecting liquid with an inlet opening and an outlet opening for draining the collected liquid, wherein the collection tray comprises a bottom with a slope to the outlet opening and the bottom of the collection tray is equipped with at least one trough.

One advantage obtained with the invention is that the outlet water and residual water are reliably cleaned of sediments. This ensures that the outlet opening and the outlet tube will not plug up. Furthermore, it is an advantage to install a valve in the outlet opening. The improved cleaning of the outlet water means that the closing function of the valve will not be adversely impacted. The outlet water herein is cleaned in a simple manner from sediments and suspended particles, so that, in its further progression, it cannot cause clogging or leaks in downstream valves. An additional advantage is that no separate components have to be used and handled by the user, so that overall a lesser maintenance effort is required for cleaning the beverage preparer.

In this regard, the bottom of the collection tray is equipped with a slope toward the outlet opening, or is positioned accordingly at a slope in the device, wherein the bottom of the collection tray or the interior surface is equipped with at least one trough. The outlet water laden with sediments or suspended particles arrives at the inlet opening at the open, top side into the collection tray and flows along the collection tray bottom to the outlet. Thus sediments are collected in the trough or in the troughs and the water swashes over the upper edge of the trough. Thus the outlet water is cleaned from sediments and moves to the outlet. The sediments and solids are collected and deposited in the troughs. Because the troughs progressively fill during continuing operation, they also have to be emptied. This is done in that the user manually flushes out the inside of the collection tray.

In this and in all other embodiments, the bottom may be equipped with a hydrophobic surface in order to attain what is known as a lotus-blossom effect.

In one favorable embodiment, the bottom of the drip tray is equipped with a structure of troughs; the majority of the troughs thus can be configured as very flat, so that the sediments can be collected across the bottom surface.

In another expedient embodiment, the trough or the troughs are disposed transverse to the slope on the bottom, which prevents sediments already settled in the troughs from being flushed out again from the trough with a new slosh of outlet water.

In an additional, advantageous embodiment, several transverse-positioned troughs are arranged in sequence in the direction of the slope. Thus a sequential cleaning of the outlet water is performed, because sediments that are carried along over the first trough land in the next sequential trough and remain there. The flow of the outlet water to the outlet side occurs due to the force of gravity and the slope in the bottom of the collection tray and/or the collection tray bottom configured as a slope.

In another preferred embodiment, the spacing of the troughs in the direction of the slope has a value in the range of 1 cm to 5 cm, preferably 1.5 to 4 cm.

In an overall advantageous embodiment, the trough or the troughs are equipped with a depth in the range between 0.5 mm to 5 mm. Thus firstly, a sufficient volume is assured to accommodate sediments, and secondly the flow of outlet water to the outlet is not too greatly impeded or retarded. Furthermore, these recesses can be readily cleaned with common household means, such as a sponge, brush or wiping cloth.

In an additional, overall expedient embodiment, the trough or the troughs extend across the entire width of the collection tray, so that the entire width of the collection tray is utilized for collection of the sediments.

In an overall advantageous embodiment, the trough or the troughs are equipped with interruptions, preferably 1 mm to 5 mm wide. These interruptions can be produced by short webs which extend from the trough out to the plane of the bottom surface.

In an overall advantageous embodiment, the trough or the troughs have a curved, bow-like configuration, wherein the convex side points to the outlet side. Thus the sediments are flushed into the trough and move into the apex region of the curvature where they remain in a stable manner. A subsequent outlet water swash cannot flush the already deposited sediments out to the side from the trough.

In an additional, overall advantageous embodiment, the trough or the troughs have a sawtooth-shaped profile, with one gently descending flank on the side facing the drain, and one steep flank, preferably vertical, on the side facing away from the drain. The outlet water flows against this step flank, so that sediments are retained at this flank and drop down to the bottom. Furthermore, this structure has the effect that already deposited sediments remain stable in the trough. A subsequent outlet water swash cannot flush the already deposited sediments upward from the trough.

In an overall expedient embodiment, the collection tray comprises a bottom with slope to the outlet opening in order to improve the run-off of the filtered outlet water.

In an additional, overall advantageous embodiment, the trough or the troughs are formed by means of recesses, for example, grooves in the plane of the bottom and/or by bulges or protrusions from the plane of the collection tray bottom. Protrusions can be viewed as strip-like elevations on the collection tray bottom.

In one preferred embodiment, the trough or the troughs are each formed from a combination of recesses and bulges, wherein preferably the recess of the trough is converted into an elevation at its end toward the outlet side. Thus a well-functioning trough with sufficient depth can be formed which extends only half way into the collection tray bottom and protrudes only half way from the plane of the surface of the container bottom.

In an additional, advantageous embodiment the structure of the troughs is formed from a combination of recesses and bulges, so that at least one trough is configured as a recess and at least one additional trough is configured as a bulge. Preferably the recesses and bulges alternate with each other. Thus a trough configured as a recess is neighboring to one configured as a bulge, and vice versa. Thus sediments are reliably held back at the bottom of the drip tray.

Several embodiments of the invention are depicted schematically in the drawings and are explained in greater detail below.

### BRIEF DESCRIPTION OF THE DRAWINGS

In the drawings,

FIG. 1: shows a hot beverage preparer in a partial, cross-sectional representation;

FIGS. 2 and 3 show the drainage device in various configurations; and

FIG. 4: shows the bottom of the collection tray in a detailed view.

### DETAILED DESCRIPTION OF THE DRAWINGS

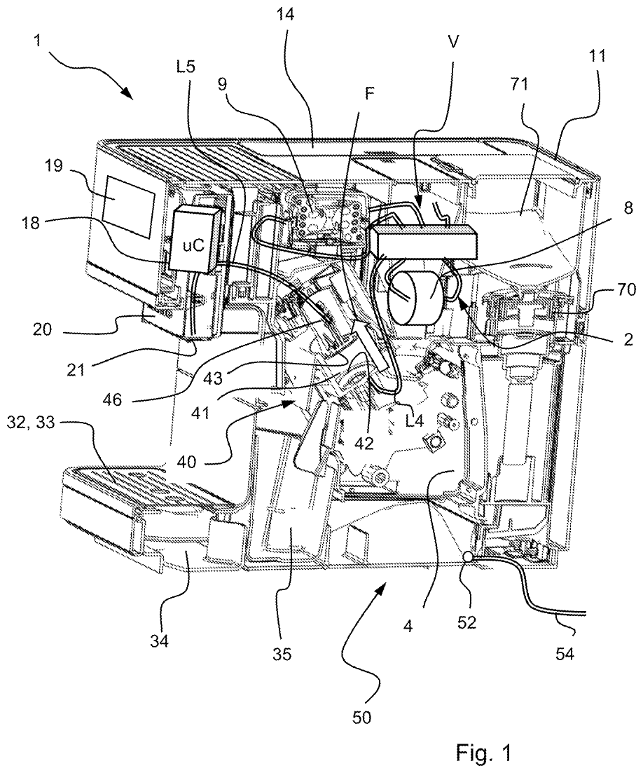

FIG. 1 shows the example of a hot beverage preparer 1 configured as an upright unit, with all relevant components for the preparation of a hot beverage. The beverage preparer 1 comprises inter alia a housing 11, in which the supply container 71 for coffee beans is located, with the grinding unit 70 with motor located underneath, the water container 14 and also a possibility for placement of the flow control system 2. In the front region of the hot beverage preparer 1 there is a height-adjustable outlet 20 in which a plurality of sampling devices are accommodated. The sampling device 21 represents an outlet line or outlet nozzle 21 for dispensing coffee beverages. A brewing unit 40 with a brewing chamber 41 in the interior of the device 1 is used for preparing the beverage, wherein the coffee powder is introduced into the brewing chamber 41 and is subsequently flooded with hot water, so that the finished coffee beverage is dispensed to the outlet line and through the dispensing nozzle 21. In this configuration the outlet nozzles 21 are height-adjustable so that they can be adapted in height to a drinking vessel placed upon the placement surface 33, without any spraying of the beverage occurring upon dispensing. A drip plate 32 equipped with openings and slots forms the upper termination of the placement surface 33 in order to divert residual liquid into a collection tray 34 provided underneath the drip plate 32. Furthermore, the hot beverage preparer 1 features a grounds container 35 in which the consumed material, such as the compressed coffee “cake” can be discarded after completion of beverage preparation. The device 1 further comprises a control unit 18 configured to control the individual functional assemblies, such as the pumps 8, valves V and heating apparatus 9 and grinding mill 70, when used, as are each necessary for preparation of the selected beverage. The control unit 18, which is configured as a microcontroller μC with an associated memory, in this embodiment is further configured to control the valves V of the flow control system 2 so that the hot water is pumped through the brewing chamber 41.

The brewing chamber 41 is of cylindrical configuration in all the embodiments explained herein, whereas the layering of substances S1, S3 and S3 is viewed as progressing from the front side of the bottom. The upper front side is sealed with the brewing screen 43 after the filling step, wherein the brewing screen 43 presses down the substances in the brewing chamber 41. The hot water is introduced into the inlet 42 at the bottom front side, wherein the brewing liquid moves through the brewing sieve 43 and preferably through a downstream pressure valve 46 to the outlet nozzle 21.

The operating and display apparatus 19 is arranged on the outside, at the front wall of the housing 11. In this example it is configured with a touch panel and a display or as a touch screen to enable inputs with respect to the beverage selection and additional settings relating to water quantity, taste intensity or type of bean. The operating and display apparatus 19 is connected to the control unit 18 and/or to the microprocessor μC for the exchange of data.

The control unit 18 with a microcontroller μC and a memory unit MEM is used for preparation of the beverage, wherein the activation of the heating unit 9, the valves of the valve apparatus V, and also of the pump 8, the brewing chamber 40 with the displaceable brewing chamber 41 and other components, if necessary, such as a grinding mill 70 proceeds by means of corresponding signal connections (not depicted).

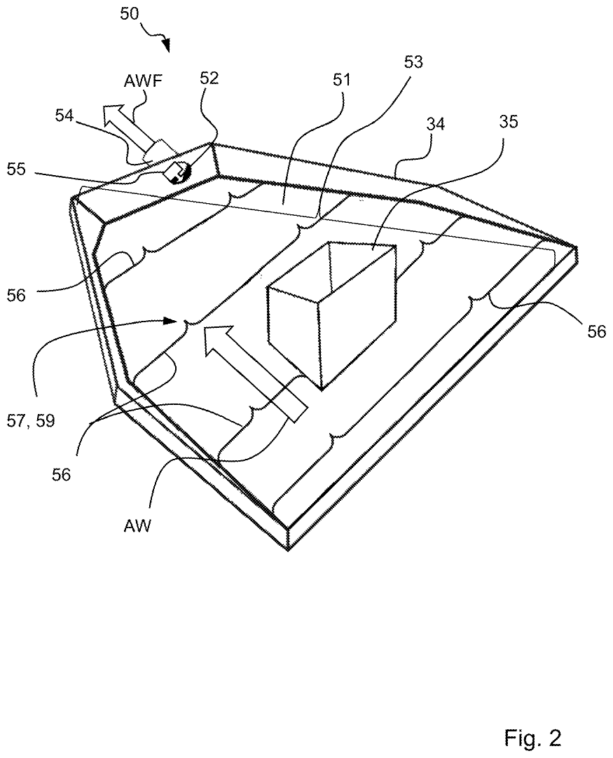

FIG. 2 shows the outlet device 50 in a detailed view. The collection tray 34 as central functional component comprises a tray bottom 51 configured with a slope to the outlet opening 52. The slope operates like a funnel in order to guide the outlet water AW arriving in the collection tray 34 to the outlet opening 52. The tray 34 is open on top and provides the inlet opening 53 for the arriving outlet water AW. In the illustration the diagonal diameter of the inlet opening 53 is bolded in order to illustrate the maximum, large cross-section. Several troughs 56 are arranged in the collection tray 34 and/or on the bottom 51 of the collection tray 34. In the illustrated example the troughs 56 extend across the entire width of the collection tray 34. The outlet opening 52 is outlet connected to the outlet tube 54 provided for connection to an outlet water channel. A one-way valve 55 can be arranged in the outlet opening 52 or directly behind it in order to prevent the exit of outlet water from the collection tray 34 when it is pulled out from the device 1. These named components and their arrangement are largely evident also in FIG. 1. In the illustrated example, the troughs 56 are of a curved configuration, wherein the bulging of the apex region 57 points to the outlet 52.

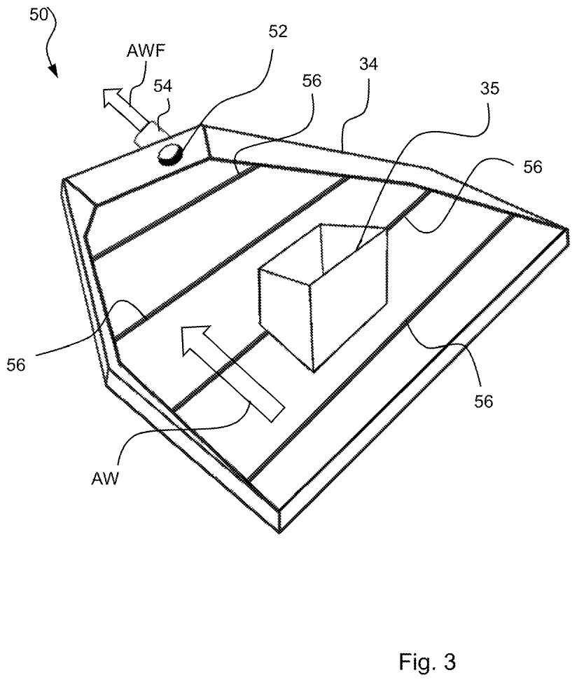

FIG. 3 depicts the drainage device 50 in a schematic view having a configuration with straight troughs 56. The collection tray 34 features a bottom 51 with a slope toward the outlet opening 52. In this case the outlet opening 52 is located preferably at the lowest point in the collection tray 34, which is not so clearly depicted in the sketch. The line 54 is connected to the outlet opening 52 and guides the filtered outlet water AWF to the outside and can be connected to an outlet channel. Possible sources of the outlet water AW can be the beverage outlet 20 and/or the outlet nozzle 21 and the brewing unit 40. Additional components, such as drain lines or valves V for draining rinse liquid or cleaning solution are also possible sources. The outlet water AW from these sources moves into the collection tray 34 and thus to the bottom 51, which in this example is located beneath the inlet opening 53.

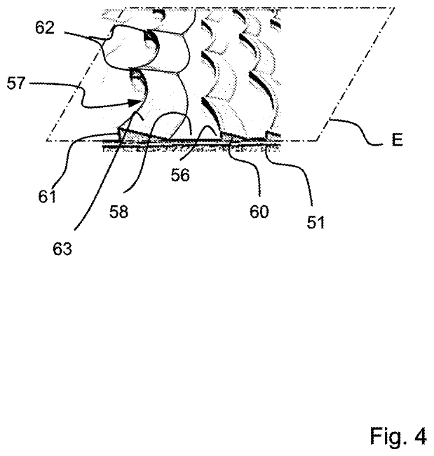

FIG. 4 depicts a section of the bottom 51 in a side view. The surface 58 located on the inside of the collection tray 34 is provided with protrusions to create a trough 56. The web-like protrusions 60 are curved, each with an apex region 57. The protrusions 60 are provided with a steep flank 61, in this case, roughly at a right angle to the plane E of the bottom surface 58; this steep flank is positioned opposite the flow direction of the fouled outlet water AW. The top side 63 of the particular protrusions 60 is configured as slanted and gently descending. This produces a sawtooth-shaped configuration of the flanges 60. The produced troughs 56 herein are each configured as approximately sawtooth-shaped or as sawtooth-shaped. The interruptions 59 (FIG. 2) can be located in the apex region 57 or in the end regions 62 of the curved bar segments 60. In an additional, not illustrated embodiment, the troughs 56 can be molded onto or milled into the collection tray bottom 51. Thus no material protrudes from the plane E of the surface 58.

1. A hot beverage preparer (1) comprising
a flow control system (2) with a water source (14);
a brewing unit (40) having a brewing chamber (41) to hold brewing material (51) and an inlet line for supplying water to the brewing chamber (41),
a heating device (9) for heating the water supplied to the brewing chamber (41),
a pump (8) configured to convey the water from the water source (14) to the brewing chamber (41),
a control device (18) to activate and deactivate actuators (8, 9, 72) for preparing a selected beverage; and
a drainage device (50) including a collection tray (34) for collecting liquid (AW), the collection tray having
an inlet opening (53),
an outlet opening (52) for draining the collected liquid (AW), and
a bottom (51) with a slope extending in a direction toward the outlet opening (52) and the bottom (51) of the collection tray (34) is equipped with at least one trough (56).

2. The hot beverage preparer according to claim 1, wherein the at least one trough (56) extends transverse to the slope.

3. The hot beverage preparer according to claim 1, wherein the at least one trough is at least two troughs (56).

4. The hot beverage preparer according to claim 3, wherein the at least two troughs are several troughs (56) arranged successively in the direction of the slope.

5. The hot beverage preparer according to claim 3, wherein the at least two troughs (56) have a distance from one another in the direction of the slope in the range of 1 cm to 5 cm.

6. The hot beverage preparer according to claim 1, wherein the at least one trough (56) has a depth in the range of 0.5 mm to 5 mm.

7. The hot beverage preparer according to claim 1, wherein the collection tray has a width transverse to the direction of the slope and the trough (56) or the troughs (56) are arranged across the entire width of the collection tray.

8. The hot beverage preparer according to claim 7, wherein the troughs (56) have interruptions (59) with a width of 1 mm to 5 mm.

9. The hot beverage preparer according to claim 1, wherein the at least one trough (56) is curved in a bow-like shape, having a convex side (57) facing the outlet opening (52).

10. The hot beverage preparer according to claim 1, wherein the at least one trough (56) is configured to have a sawtooth shaped profile with a steep flank (61) facing away from the outlet (52) and a more gently descending flank facing the outlet (52), the more gently descending flank being less steep than the steep flank.

11. The hot beverage preparer according to claim 1, wherein the bottom (52) has a bottom plane (E), with at least one recess deviating from the bottom plane forming the at least one trough (56) or with bulges or protrusions (60) deviating from the bottom plane (E) delimiting the at least one trough.

12. The hot beverage preparer according to claim 11, wherein the at least one trough (56) consists of a combination of recesses and bulges (60).

13. The hot beverage preparer according to claim 12, wherein each of the recesses transitions into an elevation (60) toward the outlet opening.

14. The hot beverage preparer according to claim 11, wherein the at least one trough (56) is at least two troughs formed from a combination of recesses and bulges (60), so that at least one of the at least two troughs (56) is configured as a recess and at least one additional trough (56) of the at least two troughs (56) is configured as a bulge (60).
